(19) United States
(12) Patent Application Publication
(10) Pub. No.: US 2026/0118051 A1
(43) Pub. Date: Apr. 30, 2026

(54) PET FEEDER, TEMPERATURE CONTROL METHOD THEREOF AND COMPUTER-READABLE STORAGE MEDIUM

(71) Applicant: UBTECH ROBOTICS CORP LTD, Shenzhen (CN)

(72) Inventors: Dianrui Zhang, Shenzhen (CN); Yudong Liu, Shenzhen (CN); Yonghua Huang, Shenzhen (CN)

(21) Appl. No.: 19/433,718

(22) Filed: Dec. 27, 2025

Related U.S. Application Data
(63) Continuation of application No. PCT/CN2023/140774, filed on Dec. 21, 2023.

(30) Foreign Application Priority Data
Oct. 20, 2023 (CN) 202311375756.X

(51) Int. Cl. F25D 29/00; A01K 5/02; F25D 21/00

(52) U.S. Cl. CPC F25D 29/00; A01K 5/0291; F25D 21/006; F25D 2600/02; F25D 2600/04

(57) ABSTRACT

A temperature control method is provided for a pet feeder that defines a food storage space and includes a refrigeration module that is configured to control a temperature in the food storage space. The method includes: acquiring a feeding time of the pet feeder; determining one or more time periods corresponding to each of a plurality of refrigeration levels of the pet feeder according to the feeding time, wherein each of the plurality of refrigeration levels corresponds to an on-duration and an off-duration of the refrigeration module; and controlling the temperature of the food storage space of the pet feeder according to the on-duration and off-duration of the refrigeration module.

### CROSS REFERENCE TO RELATED APPLICATIONS

The present application is a continuation-application of International Application PCT/CN2023/140774, with an international filing date of Dec. 21, 2023, which claims foreign priority to Chinese Patent Application No. 202311375756.X, filed on Oct. 20, 2023, in the China National Intellectual Property Administration, the contents of all of which are hereby incorporated by reference in its entirety.

### TECHNICAL FIELD

The present disclosure generally relates to pet feeders, and in particular, relates to a temperature control method, pet feeder, and computer-readable storage medium.

### BACKGROUND

With the improvement of people's material living standards, the pursuit of spiritual life has also increased. Keeping pets can enrich people's spiritual lives, bringing joy and companionship, which is why raising pets has become an increasingly popular choice.

When feeding pets, if a large amount of food is stored in the feeder, it may be affected by the environment, causing the food to spoil, which is detrimental to the health of pets. On the other hand, dispensing food on a per-meal basis requires retrieving food for each feeding, which is relatively cumbersome to operate.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a pet feeder according to one embodiment.

FIG. 2 is another schematic block diagram of the pet feeder.

FIG. 3 is an exemplary flowchart of a temperature control method for a pet feeder according to one embodiment.

FIG. 4 is a schematic diagram of level control of a pet feeder according to one embodiment.

FIG. 5 is a schematic diagram of defrosting control of a pet feeder according to one embodiment.

FIG. 6 is a block diagram of a temperature control device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

With the improvement of people's material living standards, the pursuit of spiritual life has also increased. Keeping pets can enrich people's spiritual lives, bringing joy and companionship, which is why raising pets has become an increasingly popular choice. The convenience of feeding has therefore become a major concern for people when raising pets.

In general, pet feeding is carried out by dispensing a single-meal portion, that is, providing the amount of food required for each meal at the time the pet eats. This feeding method requires manual feeding for every meal, which is relatively cumbersome. If, however, a larger quantity of food is dispensed at one time, the food may be affected by environmental conditions and become moldy or spoiled, which is detrimental to the health of the pet.

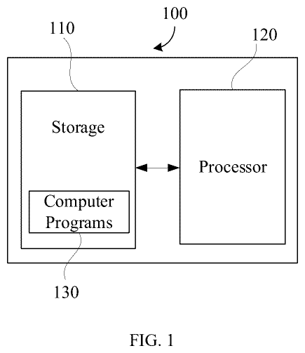

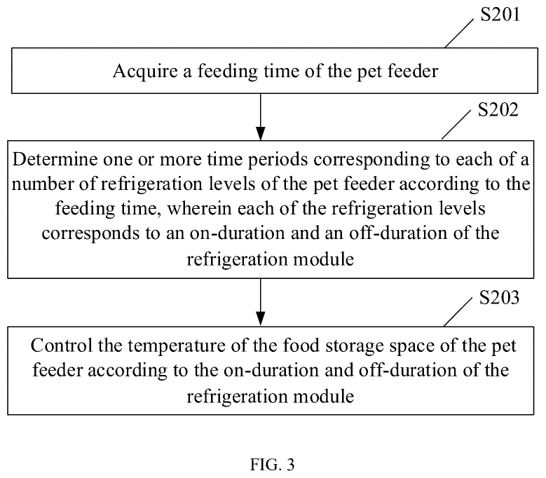

To address the above issues, embodiments of the present disclosure propose a pet feeder. Referring to FIG. 1, in one embodiment, a pet feeder 100 may include a storage 110 and a processor 120. The storage 110 and the processor 120 are directly or indirectly electrically connected to one another to enable data transmission or interaction. For example, they can be electrically connected to each another through one or more communication buses or signal lines. The processor 120 performs corresponding operations by executing the executable computer programs 130 stored in the storage 110. When the processor 120 executes the computer programs 130, the steps in the embodiments of a human body information extraction method, such as steps S201 to S203 in FIG. 3 are implemented.

The processor 120 may be an integrated circuit chip with signal processing capability. The processor 120 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 120 can implement or execute the methods, steps, and logical blocks disclosed in the embodiments of the present disclosure.

The storage 110 may be, but not limited to, a random-access memory (RAM), a read only memory (ROM), a programmable read only memory (PROM), an erasable programmable read-only memory (EPROM), and an electrical erasable programmable read-only memory (EEPROM). The storage 110 may be an internal storage unit of the pet feeder 100, such as a hard disk or a memory. The storage 110 may be an external storage device of the pet feeder 100, such as a plug-in hard disk, a smart memory card (SMC), and a secure digital (SD) card, or any suitable flash cards. Furthermore, the storage 110 may include both an internal storage unit and an external storage device. The storage 110 is to store computer programs, other programs, and data required by the pet feeder 100. The storage 110 can be used to temporarily store data that has been output or is about to be output. Upon receiving an execution instruction, the processor 120 can correspondingly execute the computer program stored on the storage 110.

Exemplarily, the one or more computer programs 130 may be divided into one or more modules/units, and the one or more modules/units are stored in the storage 110 and executable by the processor 120. The one or more modules/units may be a series of computer program instruction segments capable of performing specific functions, and the instruction segments are used to describe the execution process of the one or more computer programs 130 in the pet feeder 100.

It should be noted that the block diagram shown in FIG. 1 is only an example of the pet feeder 100. The pet feeder 100 may include more or fewer components than what is shown in FIG. 1, or have a different configuration than what is shown in FIG. 1. Each component shown in FIG. 1 may be implemented in hardware, software, or a combination thereof.

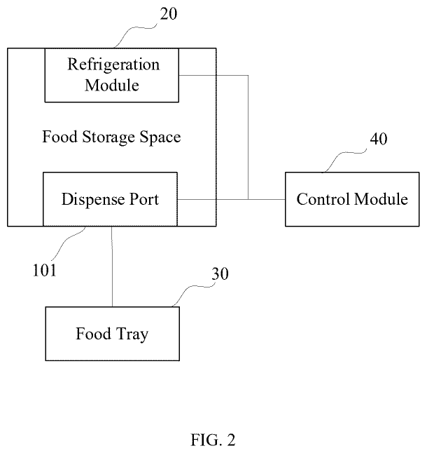

Referring to FIG. 2, in one embodiment, the pet feeder defines a food storage space 10, and incudes a refrigeration module 20 and a food tray 30, and a control module 40. The food storage space 10 may be used to store a relatively large amount of food. The food storage space 10 may be provided with a dispense port 101, which is configured to allow food in the food storage space 10 to be dispensed into food tray 30. The dispense port 101 may be controlled by the control module 40, including being controlled to an open state in which the food in the food storage space 10 can be dispensed into the food tray 30 through the discharge port 101. When the dispense port 101 is in a closed state, the food storage space 10 is sealed. The food storage space 10 may be in the form of a chamber.

The refrigeration module 20 may control the temperature inside the food storage space 10. The refrigeration module may include a mechanical refrigeration device (such as a compressor-based cooling device), a semiconductor refrigeration device, or an electronic cooling chip. The refrigeration module 20 may be controlled to operate or to be turned off according to control signals output by the control module 40. Through prior planning, the on-duration and off-duration of the refrigeration module within a control cycle can be determined for different temperatures of the food storage space 10.

The food tray 30 may be used to receive the food dispensed from the food storage space 10, allowing a pet to eat at scheduled times.

The control module 40 may control the refrigeration module 20 to operate in different working states based on the pet's meal time or feeding time. For example, multiple refrigeration levels may be preset, each corresponding to a respective on-duration and off-duration of the refrigeration module 20 within a control cycle. A corresponding refrigeration level may be selected according to the pet's feeding time, or different refrigeration levels may be selected based on a user operation command.

In one embodiment, the pet feeder may further include a heat dissipation module configured to dissipate the heat absorbed by the refrigeration module.

Referring to FIG. 3, in one embodiment, a temperature control method for the pet feeder may include steps S201 through S203.

Step S201: Acquire a feeding time of the pet feeder.

In one embodiment, the feeding times of the pet feeder 100 may be determined according to a feeding schedule set by a user. For example, the user may set the feeding frequency of the pet feeder to twice or three times a day. When the feeding schedule is set to twice daily, the feeding times can be at 9:00 a.m. and 5:00 p.m. When the feeding schedule is set to three times daily, the feeding times can be at 8:00 a.m., 12:00 p.m., and 6:00 p.m. The pet's feeding times can thus be obtained based on the feeding schedule.

In one embodiment, feeding may be carried out according to a user-issued feeding instruction. For example, the user may generate a feeding instruction by pressing a feeding button on the pet feeder, or the user may send a feeding instruction to the pet feeder via a smart device connected to the pet feeder. The times at which the pet feeder receives the feeding instructions may be determined as the feeding times.

Step S202: Determine one or more time periods corresponding to each of a number of refrigeration levels of the pet feeder according to the feeding time, wherein each of the refrigeration levels corresponds to an on-duration and an off-duration of the refrigeration module.

After the pet feeding times of the pet feeder are determined, refrigeration planning may be performed for different time ranges according to the feeding times, so that different time periods correspond to different refrigeration levels.

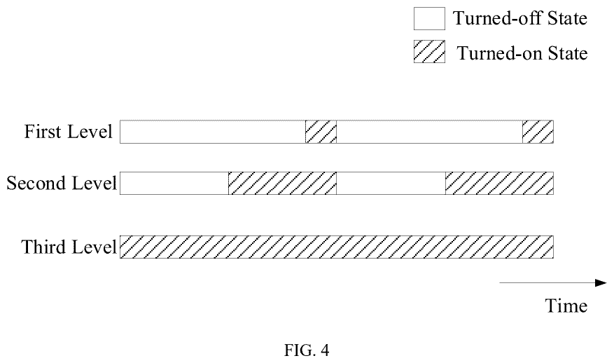

For example, in one embodiment, the pet feeder may be configured to include three levels, namely a first level, a second level, and a third level. The first level allows the temperature of the food storage space to approach room temperature while remaining lower than room temperature. As shown in the level control schematic diagram of FIG. 4, when the control module controls the food storage space to be at the first level, within one control cycle, the on-duration of the refrigeration module is less than the off-duration.

When the control module controls the food storage space to be at the second level, the time difference between the on-duration and the off-duration of the refrigeration module at the second level is smaller than a predetermined time threshold. That is, the on-duration and the off-duration of the refrigeration module differ only slightly. In this case, the temperature of the food storage space is at a medium temperature that is unfrozen and lower than the temperature corresponding to the first level.

When the control module controls the food storage space to be at the third level, the refrigeration module may remain constantly on. In this case, the temperature of the food storage space is at a relatively low temperature, and food stored at this level can achieve better preservation performance compared with the first level and the second level. When the food is in a storage state prior to feeding, the refrigeration module of the pet feeder may be set to operate at the third level. During a first predetermined period immediately before the pet is about to eat, the refrigeration module may be set to operate at the second level, and during a second predetermined period immediately before the pet is about to eat, the refrigeration module may be set to operate at the first level, where the second predetermined period occurs after the first predetermined period.

In one embodiment, since different types of food have different temperature requirements, temperatures corresponding to different food types may be set. The temperature of the food storage space is controlled through the first level, the second level, or the third level, so as to meet different temperature preservation requirements.

In one embodiment, the on-duration and the off-duration of the refrigeration module at the first level and the second level may be determined according to a desired temperature. For example, the temperature corresponding to the first level may be set to 20° C. and the temperature corresponding to the second level may be set to 10° C. Based on experimental data collected in advance, the required on-duration and off-duration of the refrigeration module for maintaining the food storage space at the corresponding temperatures may be determined.

In addition, in order to further improve the accuracy of temperature control, the storage amount in the food storage space may be detected, and the on-duration and off-duration of the refrigeration module corresponding to a temperature may be determined based on different storage amounts. For example, when the storage amount in the food storage space is ½ of the total capacity, within one control cycle, the on-duration of the first level is t1 and the off-duration is t2; when the storage amount in the food storage space is ⅓ of the total capacity, within one control cycle, the on-duration of the first level is t3 and the off-duration is t4, where t1, t2, t3, and t4 may be of different values.

In one embodiment, a correspondence relationship between different food storage amounts, different temperatures, and the on-duration and off-duration of the refrigeration module within one refrigeration cycle may be preset. The pet feeder may receive a temperature setting instruction, and, according to the temperature setting instruction, determine the amount of food in the food storage space at the current time, and determine the on-duration and the off-duration of the refrigeration module within one refrigeration cycle based on the food amount and the temperature.

The amount of food in the food storage space may be obtained by detection using a weight sensor, or alternatively, may be obtained by detection using other sensing devices, including, for example, distance sensors, to detect the remaining amount of food in the food storage space.

Step S203: Control the temperature of the food storage space of the pet feeder according to the on-duration and off-duration of the refrigeration module.

By determining the refrigeration level of the refrigeration module in the food storage space according to the pet feeding time, and controlling the on-duration and the off-duration within one refrigeration cycle based on the refrigeration level, the temperature of the food storage space at different feeding stages can be accurately controlled. This is beneficial for improving food preservation quality, reducing the likelihood or extent of food spoilage, and enhancing the convenience of pet feeding.

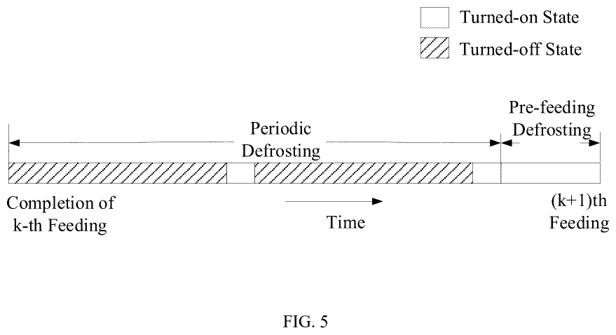

In one embodiment, when the refrigeration module operates at the first level, the temperature in the food storage space may drop to a relatively low temperature, for example, below 0° C. In this case, the food in the food storage space may become frozen. To reduce the likelihood that food cannot be successfully dispensed from the food storage space to the food tray, a pre-feeding defrosting process may be performed in advance for a predetermined duration. As shown in the schematic diagram of the operating state of the refrigeration module in FIG. 5, within a predetermined duration before the feeding time point, for example, 2-5 minutes before the feeding time point, the refrigeration module may be controlled to stop operating, so that the temperature of the food in the food storage space gradually rises and the food is released from the frozen state. During the pre-feeding defrosting period, the heat dissipation module may be kept in an operating state, or alternatively, the heat dissipation module may be controlled to be in a non-operating state.

In order to further reduce the probability that the food remains in a frozen state, periodic defrosting processing may be performed on the food when the pet feeder is in a non-feeding state.

As shown in FIG. 5, within one feeding cycle, a time period between the completion of the k-th feeding and the start time of the pre-feeding defrosting for the (k+1)-th feeding is defined as a periodic defrosting time period. Within the periodic defrosting time period, after the refrigeration module operates for a first duration, the refrigeration module may be stopped for a second duration. During the second duration in which the refrigeration module is stopped, the temperature in the food storage space rises, causing the temperature of frozen food to increase, thereby reducing food freezing.

In one embodiment, in order to reduce the impact of the refrigeration module and the heat dissipation module on the pet, the refrigeration module and the heat dissipation module may be stopped during the feeding stage of the pet feeder, thereby providing a quiet and comfortable dining environment for the pet.

In addition, the refrigeration module in the pet feeder needs to cool the food storage space, and a considerable amount of heat may be generated during operation. To improve the reliability of the pet feeder, the temperature inside the pet feeder may be monitored, particularly the temperature of the refrigeration module. When the monitored temperature exceeds a predetermined temperature threshold, the refrigeration module may be stopped to reduce the likelihood of damage to the refrigeration module.

When the monitored temperature exceeds the predetermined temperature threshold, a fault may occur in the heat dissipation module. To reduce the likelihood of accidents caused by a malfunctioning heat dissipation module, the heat dissipation module may be stopped simultaneously when the refrigeration module is stopped.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

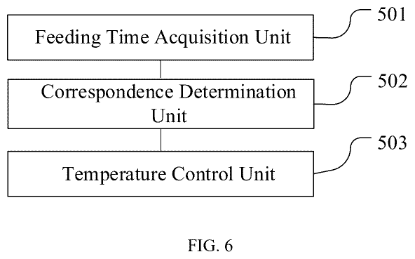

FIG. 6 is a schematic block diagram of a temperature control device for a pet feeder according to one embodiment. The pet feeder is provided with a food storage space, a refrigeration module, and a food tray. The refrigeration module is to control the temperature in the food storage space, and the food storage space is to dispense food to the food tray. As shown in FIG. 6, the device may include a feeding time acquisition unit 501, a correspondence determination unit 502, and a temperature control unit 503. The feeding time acquisition unit 501 is to acquire a feeding time of the pet feeder. The correspondence determination unit 502 is to determine one or more time periods corresponding to each of a number of refrigeration levels of the pet feeder according to the feeding time. Each of the refrigeration levels corresponds to an on-duration and an off-duration of the refrigeration module. The temperature control unit 503 is to control the temperature of the food storage space of the pet feeder according to the on-duration and off-duration of the refrigeration module.

In one embodiment, the refrigeration levels includes a first level, a second level, and a third level. In a cyclic control period of each of the refrigeration levels, the on-duration of the refrigeration module in the first level is greater than the off-duration of the refrigeration module in the first level, the difference between the on-duration and the off-duration of the refrigeration module in the second level is smaller than a predetermined time threshold, and the refrigeration module in the third level remains constantly on.

In one embodiment, the device may further includes a duration determination unit that is to, according to a correspondence between the refrigeration levels and temperatures, determine the on-duration and the off-duration of the refrigeration module in the first level, and the on-duration and the off-duration of the refrigeration module in the second level.

In one embodiment, the correspondence determination unit 502 may include a first time period determination sub-unit and a second time period determination sub-unit. The first time period determination sub-unit is to determine a predetermined duration prior to the feeding time of the pet feeder as a pre-feeding defrosting time period. The second time period determination sub-unit is to determine a time period between a moment when the food storage space dispenses food for a k-th feeding and a moment before start of pre-feeding defrosting for a (k+1)-th feeding as a periodic defrosting time period, where k is a natural number.

In one embodiment, the device further includes a heat dissipation module that is to cool the refrigeration module. The heat dissipation module is to continuously operate when the refrigeration module stops working during the pre-feeding defrosting time period. Alternatively, the heat dissipation module is to continuously operate when the refrigeration module stops working at predetermined intervals during the periodic defrosting time period.

In one embodiment, the device may further include a feeding control unit that is to, during a pet feeding stage, control the refrigeration module and the heat dissipation module to be in a turned-off state.

In one embodiment, the device may further include a temperature measurement unit and an overheat protection unit. The temperature measurement unit is to detect a temperature of the refrigeration module. The overheat protection unit is to, in response to the temperature of the refrigeration module exceeding a predetermined temperature threshold, control the refrigeration module and the heat dissipation module to stop operating.

Those skilled in the art will readily understand that, for the sake of convenience and conciseness in description, the specific working processes of the above-described device, modules, and units may refer to the corresponding processes in the foregoing method embodiments, and are not repeated herein.

In the above embodiments, the descriptions of each embodiment focus on different aspects. Any features not specifically described or disclosed in one embodiment may be referred to in the relevant descriptions of other embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented temperature control method for a pet feeder that defines a food storage space and comprises a refrigeration module that is configured to control a temperature in the food storage space, the method comprising:
acquiring a feeding time of the pet feeder;
determining one or more time periods corresponding to each of a plurality of refrigeration levels of the pet feeder according to the feeding time, wherein each of the plurality of refrigeration levels corresponds to an on-duration and an off-duration of the refrigeration module; and
controlling the temperature of the food storage space of the pet feeder according to the on-duration and off-duration of the refrigeration module.

2. The method of claim 1, wherein the plurality of refrigeration levels comprise a first level, a second level, and a third level; in a cyclic control period of each of the refrigeration levels, the on-duration of the refrigeration module in the first level is less than the off-duration of the refrigeration module in the first level, the difference between the on-duration and the off-duration of the refrigeration module in the second level is smaller than a predetermined time threshold, and the refrigeration module in the third level remains constantly on.

3. The method of claim 2, further comprising, before determining the one or more time periods corresponding to each of the plurality of refrigeration levels of the pet feeder according to the feeding time,
according to a correspondence between the refrigeration levels and temperatures, determining the on-duration and the off-duration of the refrigeration module in the first level, and the on-duration and the off-duration of the refrigeration module in the second level.

4. The method of claim 1, wherein determining the one or more time periods corresponding to each of the plurality of refrigeration levels of the pet feeder according to the feeding time, comprises:
determining a predetermined duration prior to the feeding time of the pet feeder as a pre-feeding defrosting time period; and
determining a time period between a moment when the food storage space dispenses food for a k-th feeding and a moment before start of pre-feeding defrosting for a (k+1)-th feeding as a periodic defrosting time period, wherein k is a natural number.

5. The method of claim 4, wherein the pet feeder further comprises a heat dissipation module configured to cool the refrigeration module, the heat dissipation module is configured to continuously operate when the refrigeration module stops working during the pre-feeding defrosting time period, or the heat dissipation module is configured to continuously operate when the refrigeration module stops working at predetermined intervals during the periodic defrosting time period.

6. The method of claim 5, further comprising: during a pet feeding stage, controlling the refrigeration module and the heat dissipation module to be in a turned-off state.

7. The method of claim 5, further comprising:
detecting a temperature of the refrigeration module; and
in response to the temperature of the refrigeration module exceeding a predetermined temperature threshold, controlling the refrigeration module and the heat dissipation module to stop operating.

8. A pet feeder comprising:
food storage space;
a refrigeration module that is configured to control a temperature in the food storage space;
one or more processors; and
a memory coupled to the one or more processors, the memory storing programs that, when executed by the one or more processors, cause performance of operations comprising:
acquiring a feeding time of the pet feeder;
determining one or more time periods corresponding to each of a plurality of refrigeration levels of the pet feeder according to the feeding time, wherein each of the plurality of refrigeration levels corresponds to an on-duration and an off-duration of the refrigeration module; and
controlling the temperature of the food storage space of the pet feeder according to the on-duration and off-duration of the refrigeration module.

9. The pet feeder of claim 8, wherein the plurality of refrigeration levels comprise a first level, a second level, and a third level; in a cyclic control period of each of the refrigeration levels, the on-duration of the refrigeration module in the first level is less than the off-duration of the refrigeration module in the first level, the difference between the on-duration and the off-duration of the refrigeration module in the second level is smaller than a predetermined time threshold, and the refrigeration module in the third level remains constantly on.

10. The pet feeder of claim 9, wherein the operations further comprise, before determining the one or more time periods corresponding to each of the plurality of refrigeration levels of the pet feeder according to the feeding time,
according to a correspondence between the refrigeration levels and temperatures, determining the on-duration and the off-duration of the refrigeration module in the first level, and the on-duration and the off-duration of the refrigeration module in the second level.

11. The pet feeder of claim 8, wherein determining the one or more time periods corresponding to each of the plurality of refrigeration levels of the pet feeder according to the feeding time, comprises:
determining a predetermined duration prior to the feeding time of the pet feeder as a pre-feeding defrosting time period; and
determining a time period between a moment when the food storage space dispenses food for a k-th feeding and a moment before start of pre-feeding defrosting for a (k+1)-th feeding as a periodic defrosting time period, wherein k is a natural number.

12. The pet feeder of claim 11, further comprising a heat dissipation module configured to cool the refrigeration module, wherein the heat dissipation module is configured to continuously operate when the refrigeration module stops working during the pre-feeding defrosting time period, or the heat dissipation module is configured to continuously operate when the refrigeration module stops working at predetermined intervals during the periodic defrosting time period.

13. The pet feeder of claim 12, wherein the operations further comprise, during a pet feeding stage, controlling the refrigeration module and the heat dissipation module to be in a turned-off state.

14. The pet feeder of claim 12, wherein the operations further comprise:
detecting a temperature of the refrigeration module; and
in response to the temperature of the refrigeration module exceeding a predetermined temperature threshold, controlling the refrigeration module and the heat dissipation module to stop operating.

15. A non-transitory computer-readable storage medium storing instructions that, when executed by at least one processor of an electronic device, cause the at least one processor to perform a temperature control method for a pet feeder that defines a food storage space and comprises a refrigeration module that is configured to control a temperature in the food storage space, the method comprising:
acquiring a feeding time of the pet feeder;
determining one or more time periods corresponding to each of a plurality of refrigeration levels of the pet feeder according to the feeding time, wherein each of the plurality of refrigeration levels corresponds to an on-duration and an off-duration of the refrigeration module; and
controlling the temperature of the food storage space of the pet feeder according to the on-duration and off-duration of the refrigeration module.

16. The non-transitory computer-readable storage medium of claim 15, wherein the plurality of refrigeration levels comprise a first level, a second level, and a third level; in a cyclic control period of each of the refrigeration levels, the on-duration of the refrigeration module in the first level is less than the off-duration of the refrigeration module in the first level, the difference between the on-duration and the off-duration of the refrigeration module in the second level is smaller than a predetermined time threshold, and the refrigeration module in the third level remains constantly on.

17. The non-transitory computer-readable storage medium of claim 16, wherein the method further comprises, before determining the one or more time periods corresponding to each of the plurality of refrigeration levels of the pet feeder according to the feeding time,
according to a correspondence between the refrigeration levels and temperatures, determining the on-duration and the off-duration of the refrigeration module in the first level, and the on-duration and the off-duration of the refrigeration module in the second level.

18. The non-transitory computer-readable storage medium of claim 15, wherein determining the one or more time periods corresponding to each of the plurality of refrigeration levels of the pet feeder according to the feeding time, comprises:
determining a predetermined duration prior to the feeding time of the pet feeder as a pre-feeding defrosting time period; and
determining a time period between a moment when the food storage space dispenses food for a k-th feeding and a moment before start of pre-feeding defrosting for a (k+1)-th feeding as a periodic defrosting time period, wherein k is a natural number.

19. The non-transitory computer-readable storage medium of claim 18, wherein the pet feeder further comprises a heat dissipation module configured to cool the refrigeration module, the heat dissipation module is configured to continuously operate when the refrigeration module stops working during the pre-feeding defrosting time period, or the heat dissipation module is configured to continuously operate when the refrigeration module stops working at predetermined intervals during the periodic defrosting time period.

20. The non-transitory computer-readable storage medium of claim 19, wherein the method further comprises, during a pet feeding stage, controlling the refrigeration module and the heat dissipation module to be in a turned-off state.
